(19) United States
(12) Patent Application Publication
(10) Pub. No.: US 2014/0267749 A1
(43) Pub. Date: Sep. 18, 2014

(54) SYSTEM, METHOD AND DEVICE FOR LIVE STREAM EDITING

(71) Applicant: Xumanii, Carson City, NV (US)

(72) Inventor: Alexandre Frigon, George Town (KY)

(21) Appl. No.: 13/932,645

(22) Filed: Jul. 1, 2013

Related U.S. Application Data
(60) Provisional application No. 61/788,005, filed on Mar. 15, 2013.

(51) Int. Cl. H04N 1/00; G06F 3/00

(52) U.S. Cl. CPC H04N 1/00244; G06F 3/005
USPC 348/159

(57) ABSTRACT

A system, method, computer-readable medium and device for editing a live-streamed video which may include video capture devices having a camera and a encoding device, a network having routers, and a computing device having video editing software. Each video capture device captures and digitally encodes a live video stream, communicating it to the computing device via the network. The computing device receives the video streams and displays them to a user, allowing the user to select a first video stream to be published in a live video feed, transmitting the first video stream to a server for publication in the live video feed, and allowing the user to select a second video stream from the plurality of video streams to be published, and transmitting the second video stream to a server for publication such that the live video feed transitions from the first video stream to the second video stream.

### CROSS REFERENCE TO RELATED APPLICATIONS

This application claims the benefit of U.S. Provisional Application Ser. No. 61/788,005 filed Mar. 15, 2013, the disclosure of which is hereby incorporated herein by reference in its entirety.

### BACKGROUND AND FIELD OF ART

The invention generally relates to the field of live-editing and publishing video streams.

Live editing of video stream has been known for decades. Many news services provide live broadcasts and/or live updates to viewers with the ability to change from camera to camera, swapping between video feeds or mixing video feeds. However, traditionally this has been accomplished using highly specialized, and expensive equipment, such as tricasters, with add-on sound delay equipment and other such devices.

With the advent of the Internet and live-stream video technology, such as webcams, face-to-face communication software and websites like Stickam.com, anybody can stream live video of events, video games, or even home videos. However, non-professional users have little to no options with respect to editing their live stream. Generally a camera can be set up to transmit directly to a computer or server where it is then published via the Internet, and rudimentary tools may provide the option of adding a simple overlay to the video. However, an amateur film producer looking to use several camera sources to produce a single video stream generally cannot do so in a real-time setting. The live-video editing equipment is generally cost-prohibitive for the non-professional user.

Accordingly, there is a long felt need for an inexpensive solution which can provide amateurs with video editing tools that have similar features and options to those found in the professional-grade equipment. The invention disclosed herein is designed to provide users with such a solution by providing relatively inexpensive software and hardware solutions which enable a user to live-edit video streams.

The disclosed concept also presents a novel video encoding device which can enable any HD camera to provide a video stream to a computing device for use with the disclosed concepts. While professional grade cameras, such as those used by television news crews may come with wireless transmission functionality built in, these cameras are expensive and outside of the price range of most amateur film makers. The video encoding device provides a novel combination of existing technologies to provide a lower cost solution that can convert a regular digital video camera into a live video stream source for a computing device.

Once the live stream video has been encoded, edited and published, consumers can download and watch the live stream. However, many servers put artificial limitations on the download speed and bandwidth allotted per connection to the server. Accordingly, even where a user may have a fast internet connection, intermediary servers may be a bottleneck to the users' ability to view a live stream or to the quality of the image the user receives. The disclosed concept provides a novel manner of increasing bandwidth in such circumstances by presenting a video player software that opens a multi-threaded connection between the user's computer and the server publishing the video feed such that the packets of the video feed are split between the multi-threaded connection and reassembled on the user's computer in order to increase performance beyond the limits placed by the server or intermediary servers for single-thread connections.

The disclosed concepts also include a novel incentivized social media promotional method for social networking sites such as Facebook. Such sites generally have a “wall” or bulletin board feature allowing users to post messages and links for others to view and share. However, a user must approve or write in the messages that are posted to the wall. The disclosed concept provides a novel manner of using the wall feature of social networking cites to make users into promoters for their favorite artists/content providers.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention is generally directed to a system, method, device and computer program product for recording, editing and publishing a live video stream.

In one embodiment, a system for editing a live-streamed video may include a plurality of video capture devices, each video capture device comprising a video camera and a video encoding device, a network comprising one or more routers, and a computing device having video editing software. Each of the plurality of video capture devices captures and digitally encodes a live video stream, and electronically communicates the encoded live video stream to the computing device via the one or more routers. The computing device receives the plurality of video streams from the plurality of video capture devices and is capable of displaying the plurality of video streams to a user, allowing the user to select a first video stream from the plurality of video streams to be published in a live video feed, transmitting the first video stream to a server for publication in the live video feed, allowing the user to select a second video stream from the plurality of video streams to be published in a live video feed, and transmitting the second video stream to a server for publication in the live video feed such that the live video feed transitions from the first video stream to the second video stream.

In another embodiment a method for editing a live-streamed video includes the steps of: a. capturing a plurality of video streams using a plurality of video capture devices, wherein each video capture device comprising a video camera and a video encoding device; b. encoding and electronically communicating each of the plurality of video streams to a computing device having video editing software via a network of one or more routers; c. displaying the plurality of video streams to a user; d. selecting a first video stream from the plurality of video streams to be published in a live video feed; e. transmitting the first video stream to a server for publication in the live video feed; f. selecting a second video stream from the plurality of video streams to be published in a live video feed; and g. transmitting the second video stream to a server for publication in the live video feed such that the live video feed transitions from the first video stream to the second video stream.

In another embodiment, a computer readable medium containing program instructions for editing a live-streamed video, wherein execution of the program instructions by one or more processors of a computer system causes the one or more processors to carry out the steps of: a. displaying the plurality of video streams to a user; b. selecting a first video stream from the plurality of video streams to be published in a live video feed; c. transmitting the first video stream to a server for publication in the live video feed; d. selecting a second video stream from the plurality of video streams to be published in a live video feed; and e. transmitting the second video stream to a server for publication in the live video feed such that the live video feed transitions from the first video stream to the second video stream.

In another embodiment a computing device for live video editing includes a communication interface to enable one or more network connections, such that the computing device is capable of receiving a plurality of video streams and of transmitting a live video feed, a visual output and a video editing software module. The video editing software module is capable of transmitting the plurality of video streams to the visual output for display, accepting a user to selection of a first video stream from the plurality of video streams to be published in a live video feed, transmitting the first video stream to a server for publication in the live video feed, accepting a user to selection of a second video stream from the plurality of video streams to be published in a live video feed, and transmitting the second video stream to a server for publication in the live video feed such that the live video feed transitions from the first video stream to the second video stream.

In another embodiment, a video encoding device includes a video encoder, one or more video input interfaces capable of connecting to a camera, a visual display and input device, and one or more transmission output interfaces. The video encoder is capable of receiving a video stream from the camera via the one or more video input interfaces, encoding the video stream into a codec, and outputting the encoded video stream to the one or more transmission outputs.

In another embodiment, a method for sending a multi-threaded video transmission includes the steps of: a. dividing a video stream into packets, wherein each packet contains information regarding the packet's order in the video stream; b. assigning each packet to one of the plurality of threads for transmission to a destination; and c. transmitting the video stream to the destination by having each of a plurality of threads open a connection to a destination and send the packets that are assigned to it to the destination.

In another embodiment, a method for receiving a multi-threaded video transmission includes the steps of: a. receiving a plurality of separate transmissions containing packets related to a video stream, wherein each packet contains information regarding the packet's order in the video stream; and b. assembling the video stream by combining the packets from the separate transmissions in the order it belongs in the video stream.

In another embodiment, a method for electronic publication of information includes the steps of: a. incentivizing users having a web page on a social media site to install a promotional app; b. allowing the users to select a set of content they wish to promote; and c. having the user promote the set of content selected by the user by publishing links and/or other promotional material for live stream events related to the set of content selected by the user on the web page of the user.

### DESCRIPTION OF THE DRAWINGS

FIG. 1 illustrates an example of a suitable computing system environment on which features of the disclosed concept may be implemented.

FIG. 2 illustrates a system diagram of the disclosed concept for video recording, editing and publishing in accordance with one embodiment.

FIG. 3 illustrates an exemplary embodiment of a graphical user interface for the video editing software of the disclosed concept.

FIG. 4 illustrates a system diagram of the video capture device in accordance with one embodiment.

FIG. 5 illustrates a digitized and encoded video stream divided into packets in accordance with one embodiment.

FIG. 6 illustrates the multi-threaded video player of the disclosed concept in accordance with one embodiment.

### DETAILED DESCRIPTION OF ILLUSTRATIVE EMBODIMENTS OF THE INVENTION

The present invention is generally directed to a system, method, device and computer program product for recording, editing and publishing. Accordingly, implementations of the invention include, or involve the use of computing devices.

Specifically, embodiments of present invention may be implemented on one or more computing devices, including one or more servers, one or more client terminals, including computer terminals, a combination thereof, or on any of the myriad of computing devices currently known in the art, including without limitation, personal computers, laptops, notebooks, tablet computers, touch pads (such as the Apple iPad, SmartPad Android tablet, etc.), multi-touch devices, smart phones, personal digital assistants, other multi-function devices, stand-alone kiosks, etc. An exemplary computing device for implementing a computational device is illustrated in FIG. 1.

FIG. 1 illustrates an example of a suitable computing system environment 200 on which features of the invention may be implemented. The computing system environment 200 is only one example of a suitable computing environment and is not intended to suggest any limitation as to the scope of use or functionality of the invention. Neither should the computing environment 200 be interpreted as having any requirement relating to any one or combination of components illustrated in the exemplary operating environment 200.

The invention is operational with numerous other computing system environments or configurations. Examples of well known computing systems, environments, and/or configurations that may be suitable for use with the invention include, but are not limited to, personal computers, server computers, hand-held, notebook or laptop devices, touch pads, multi-touch devices, smart phones, other multi-function devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by one or more computing devices. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system that may be used for implementing the invention includes a computing device 210 which may be used for implementing a client, server, mobile device or other suitable environment for the invention. Components of computing device 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computing device 210 typically includes a variety of computer readable media. Computer readable media may be defined as any available media that may be accessed by computing device 210 and includes both volatile and nonvolatile media, removable and non-removable media. By way of example, and not limitation, computer readable media may include computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computing device 210. Combinations of the any of the above should also be included within the scope of computer readable media.

The system memory 230 may include computer storage media in the form of volatile and/or nonvolatile memory such as read only memory (ROM) 231 and random access memory (RAM) 232. A basic input/output system 233 (BIOS), containing the basic routines that help to transfer information between elements within computing device 210, such as during start-up, is typically stored in ROM 231. RAM 232 typically contains data and/or program modules that are immediately accessible to and/or presently being operated on by processing unit 220. By way of example, and not limitation, FIG. 1 illustrates operating system 234, application programs 235, other program modules 236, and program data 237.

The computing device 210 may also include other removable/non-removable, volatile/nonvolatile computer storage media. By way of example only, FIG. 1 illustrates a hard disk drive 240 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing device 210. In FIG. 1, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 162 and pointing device 161, commonly referred to as a mouse, trackball, touch screen, or multi-touch input device. Other input devices (not shown) may include a microphone, joystick, game pad, satellite dish, scanner, movement sensor device such as the Microsoft Kinect or the like. These and other input devices are often connected to the processing unit 220 through a user input interface 160 that is coupled to the system bus, but may be connected by other interface and bus structures, such as a parallel port, game port or a universal serial bus (USB). A monitor 191 or other type of display device may also be connected to the system bus 221 via an interface, such as a video interface 190. In addition to the monitor, computers may also include other peripheral output devices such as speakers 197 and printer 196, which may be connected through an output peripheral interface 195.

The computing device 210 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computing device 210, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computing device 210 is connected to the LAN 171 through a network interface or adapter 170. When used in a WAN networking environment, the computer 210 typically includes a modem 172 or other means for establishing communications over the WAN 173, such as the Internet. The modem 172, which may be internal or external, may be connected to the system bus 221 via the user input interface 160, or other appropriate mechanism. In a networked environment, program modules depicted relative to the computing device 210, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

FIG. 2 depicts an exemplary system diagram of a system for recording, editing and publishing a live-streamed video. A computing device 10 with video editing software 11 is connected to the Internet 1 and to a plurality of video capture devices 21, 22 via a network comprising a one or more routers 20.

The video capture devices 21, 22 may include a video camera capable of recording a live video feed, and a video encoding device which can transmit the live video feed to the computing device 10 via the routers 20. As shown in FIG. 2, some video capture devices 21 may connect wirelessly to the routers via any of the wireless networking protocols known to persons of skill in the art, while other video capture devices 22 may have a hardline connection to the routers, such as an Ethernet or fiber optic cable connection or any other suitable connection. In the exemplary embodiment depicted in FIG. 2, the network formed by the routers is a LAN or WAN, but the invention can be practiced with any sort of connection between the video capture devices 21, 22 and the computing device 10, including connections via the Internet, direct wireless and wired connections between the video capture devices 21, 22 and the computing device, and any other suitable connection known in the art. In some embodiments, all of the plurality of video streams may be transmitted to the computing device via the same connection (for example via a wireless connection to one of the routers 20 in the network). In other embodiments, each video capture device may connect to the computing device via a separate connection. In yet other embodiments, some video capture devices 21, 22 may connect to the computing device 10 via a dedicated connection while other video capture devices 21, 22 may share a connection.

The computing device 10 in the exemplary embodiment is a laptop computer, but can be any suitable computing device capable of running the video editing software 11, including a desktop computer, tablet, smart phone, etc. The computing device 10 has, or is connected to a video output device, such as a monitor or screen. The computing device 10 is capable of receiving a plurality of video streams from the plurality of video capture devices 21, 22. The computing device 10 has, or is connected to, computer storage media, such as a hard disk or RAM on which is stored video editing software 11 which the computing device 10 is capable of running. The video editing software can be used to select the video stream from a video capture device to be published, and to be capable of transitioning between the plurality of video streams to publish a different video stream when the user so desires. Once the video to be streamed has been selected, the video editing software 11 encodes the video into the desired format (i.e. MPEG, AVI, MP4, etc.), the computing device 10 can transmit the encoded video stream to a website or server via a network connection (Internet, LAN or otherwise) for publication. In some embodiments the computing device 10 may be configured as a server and capable of publishing the video stream directly.

FIG. 3 depicts an exemplary embodiment of the graphical user interface of the video editing software 11. The video editing software 11 may provide a graphical user interface having a plurality of camera views 12, one or more camera status windows 13, a control panel 14, and a live stream view window 15. The plurality of camera views 12 may show the user the plurality of video streams coming from each of the plurality of video capture devices 21, 22 and enables the user to select the video stream to be shown in the live stream. The user may select the video to be shown in the live stream by clicking on that video stream, or in any other suitable manner known in the art. The video editing software 11 may allow the user to select the type of transition between video feeds desired. For example a user may elect to have the live stream simply alternate from one video stream to another video stream. Alternatively one video stream may fade out while the other fades in, or slide off to one side of the live stream while the newly selected video stream slides in from the other side. In short, an implementation of the disclosed concepts can allow a user to select any method of transitioning from one video stream to another. The method of selection can be done in any suitable manner known in the art, such as right clicking on a video feed and selecting from a drop down menu of transition types, or by including a transition type panel in the control panel 14 to allow the user to select the type of transition to be used. The graphical user interface 11 may also provide a button on one or more of the camera views which allows the user of the computing device 10 to communicate with the cameraman operating the respective video capture device. The button, when pressed, may activate a microphone on the computing device 10, record a voice message, and transmit that voice message to the operator either via a speaker (or headset) on or connected to the video capture device, or to an ear piece, headset or similar device that is connected to the computing device via the network.

As shown in FIG. 3, the graphical user interface may also include one or more camera status windows 13. The camera status windows may provide information to the user regarding the status of each of the plurality of video capture devices 21, 22. This information may be displayed at all times, or may be displayed only when requested by the user. The camera status window(s) may appear as an overlay on each of the plurality of camera views 10, may be a single section of the control panel 14, or may be a separate section of the graphical user interface altogether. The information displayed by the camera status window(s) may include battery life for the video capture devices 21, 22, the location of the video capture device 21, 22 (i.e. which router 20 or other relay the video capture devices 21, 22 use to connect to the network), the wireless strength of the connection between the video capture device 21, 22 and the router 20.

The control panel 14 may have a sound control section which allows the user to select and/or mix the sounds to be included in the live stream. For example, each video capture device may have an associated microphone which transmits a sound feed (either independently or together with the video stream) to the computing device. The video editing software may separate out the sound from each of the video streams and allow the user to listen to each and select when each should be selected for inclusion in the live stream, or—at the user's option—simply mute that sound feed and instead provide a separate sound feed. A sound board may be included in the control panel to allow the user to select and add pre-recorded sounds (such as sound effects, sound tracks, background music, etc.), to select or mix sound feeds, and to control the respective volumes of the sounds being mixed into the live stream. The control panel 14 may also have a sound delay control which can be used to synchronize the sound and video in circumstances when one is arriving at the computing device faster than the other. The sound delay control may be global or may be specific to each camera feed. Persons of skill in the art will recognize that the sound control section may be implemented to be as simple or as complex as desired, and can include sound filters, frequency modulators, volume controls, a database of sound effects, and any of the other sound controls currently known in the art. Indeed the sound control section can be implemented so as to give the user the maximum amount of control over the sound to be included in the live stream desired. This may include inputs having separate sound feeds from sound capture devices (not shown) which transmit a sound feed to the computing device 10, and which can also be mixed in. A user can select to display the sound feed that corresponds to the video stream selected for the live stream, a sound feed corresponding to a video stream not selected for the live stream, a separate sound feed, or any mixture of such sound feeds and such additional sounds as desired.

Once the desired video and sounds are selected for the live stream, the video editing software encodes the live stream in the desired codec. Any of the codecs and video formats known in the art, including without limitation, .wav, .avi, .gif, .mp4, MPEG, etc., may be used. The selected sound may be encoded together with the video, or separately, as desired. The encoded data is then transmitted to the website or server hosting the live stream for publication. In some embodiments, this is accomplished by transmitting the encoded live stream to the website or server via the Internet. In such embodiments the bit rate and quality of the encoding may be automatically selected based on the connection speed and bandwidth between the computing device 10 and the server. In other embodiments the user may select the bit rate and video quality to be used for the publication of the live stream. The video editing software 11 may also allow the user to record and keep a copy of the live stream and/or each individual video stream from the plurality of video capture devices 21, 22.

FIG. 4 depicts a video encoding device 30 that may be used in a video capture device, 21, 22 to transmit video from the video capture device 21, 22 to the computing device 10. Alternatively the video encoding device may be used to transmit a video feed directly to a website or server for direct, unedited publication. The video encoding device may include a video encoder 31, a video input connection 32, a visual display and input device 33, transmission outputs 34a,b&c, a power connection device 35, a power supply 36, a charger/battery selector 37, a battery bank 38, and a micro-controller 39.

A digital camera's video out may be connected to the video inputs 32 of the video encoding device 30. The video input can be any type of video input connection known in the art, including HDMI, VGA, HD SDI, fiber optic, component video, or any other suitable connection. The video input 32 passes the video stream to the video encoder 31 which encodes and compresses the raw video feed into the desired format (MPEG, AVI, etc.). The video encoder may be any video encoder known in the art or developed in the future, including without limitation a H.264 Video Encoder. Once the video has been encoded, it can be transmitted either to a computing device 10 for video editing and publication as described above, or directly to a website or server for immediate, unedited publication. This may be accomplished by means of one or more network connections selected from all such types of network connections known in the art. These may include a cellular phone network connection 34a, such as a 3G or 4G modem (and associated SIM card), a wireless networking connection 34b, such as a 802.11a,b,g,n WiFi Module, or a wired network connection 34c, such as a RJ-45 ethernet connection. Some embodiments may have only one such connection while others may have these and other additional types of connections currently known in the art.

A visual display and input device 33, such as an LCD display and control set may be included to provide the video capture device 21, 22 operator visual feedback on the status of the video encoding. This may include information as to battery life, signal strength, recording time, error messages from the video encoder, etc. The operator can then use the control set, such as menu navigation/selection buttons and/or a two axis thumb pad to operate the visual display and change the encoding and transmission settings in the video encoding device 30, as well as any other settings that may need adjustments (display brightness, power mode/usage, etc.).

A power connection device 35 may be included to allow the video encoder device to be plugged in and charged or operated while plugged in. The power connection device can be connected to the power utility grid, and is connected to the video encoder's 30 power supply 36, which converts AC power to a regulated DC power. The power supply 36 is in turn connected to a charger/battery selector 37, which can select to provide power to the video encoding device 30 from the power supply 36 and charge the batteries in the battery bank 38 when the video encoding device 30 is plugged in to the utility grid. When the video encoding device is not plugged in, the recharger/battery selector can select which of the batteries in the battery bank 38 to draw power from to operate the video encoding device 30 and alternate as needed as the batteries become depleted. Additionally, in some embodiments the batteries in the battery bank may be hot-swappable. In such embodiments when one battery is running low, the operator can remove that battery and replace it with another while the camera is running. The battery selector/detects the change in power and swaps to another battery (assuming it was not already on the other battery) so that the video stream that is being encoded is not interrupted. The hot-swappable battery bank allows the video encoder 30 to continuously encode and stream video without interruption.

As shown in FIG. 4, a processor 39 may be included in the video encoder 30 which supervises and controls the power system. Suitable processors such as the Cortex M3 controller are available in the market.

FIGS. 5 and 6 illustrate the manner in which a multi-threading video streaming aspect of the disclosed concept achieves better performance than the traditional single-thread stream. FIG. 5 illustrates a video stream that has been divided into packets for transmission to a user. In a traditional solution, the packets would be sent via a single-thread communication protocol in order to the user's computer and be subject to artificial limits on bandwidth placed by servers on individual threads. For example, if a server limits a connection to 2 Mbps, regardless of the speed of a user's Internet access, the user may be limited to the 2 Mbps.

In FIG. 6, the disclosed illustrates how to improve performance by establishing a multi-threaded connection 41, 42 between the server 40 and the user's computer 50. The packets a-e shown in FIG. 5 contain information regarding the order in which they are to be assembled. The server transmits these packets to the user's computer via the multiple-thread connection 41, 42. Accordingly, packets are divided and sent along each thread 41, 42 of the multi-threaded connection, and in doing so the overall bandwidth of the connection between the server and the user's computer is increased based upon the number of threads that are used. Accordingly, where a single-thread connection might be limited to 2 Mbps, a two-thread connection could double the bandwidth available to the user.

The disclosed concepts also include a novel incentivized social media promotional method for social networking sites such as Facebook. Users of such sites can be incentivized to download and install a promotional app by being offered rewards, or a chance at rewards, in exchange for installing the app. For instance a user might be offered a chance at winning tickets for a band or artist. The user can then use the app to select the artists or bands that they wish to promote and authorize the app to post promotional materials related to live streaming events that artist or band on the user's wall. Accordingly the user becomes a promoter for the artist's live stream events. In some embodiments users may be rewarded for become promoters for additional artists or bands or for continuing to be a promoter. Additionally, in some embodiments, a user ID code is embedded in the links that are posted on the user's wall, and the user may be rewarded for every person that clicks the link, or watches the live stream broadcast event that was promoted.

I claim:

1. A system for editing a live-streamed video comprising:
a plurality of video capture devices, each video capture device comprising a video camera and a video encoding device;
a network comprising one or more routers;
a computing device having video editing software;
wherein each of the plurality of video capture devices captures and digitally encodes a live video stream, and electronically communicates the encoded live video stream to the computing device via the one or more routers;
wherein the computing device receives the plurality of video streams from the plurality of video capture devices and the computing device is capable of
displaying the plurality of video streams to a user;
allowing the user to select a first video stream from the plurality of video streams to be published in a live video feed;
transmitting the first video stream to a server for publication in the live video feed;
allowing the user to select a second video stream from the plurality of video streams to be published in a live video feed; and
transmitting the second video stream to a server for publication in the live video feed such that the live video feed transitions from the first video stream to the second video stream.

2. A method for editing a live-streamed video comprising the steps of:
a. capturing a plurality of video streams using a plurality of video capture devices, wherein each video capture device comprising a video camera and a video encoding device;
b. encoding and electronically communicating each of the plurality of video streams to a computing device having video editing software via a network of one or more routers;
c. displaying the plurality of video streams to a user;
d. selecting a first video stream from the plurality of video streams to be published in a live video feed;
e. transmitting the first video stream to a server for publication in the live video feed;
f. selecting a second video stream from the plurality of video streams to be published in a live video feed; and
g. transmitting the second video stream to a server for publication in the live video feed such that the live video feed transitions from the first video stream to the second video stream.

3. A computer readable medium containing program instructions for editing a live-streamed video, wherein execution of the program instructions by one or more processors of a computer system causes the one or more processors to carry out the steps of:
a. displaying a plurality of video streams to a user;
b. selecting a first video stream from the plurality of video streams to be published in a live video feed;
c. transmitting the first video stream to a server for publication in the live video feed;
d. selecting a second video stream from the plurality of video streams to be published in a live video feed; and
e. transmitting the second video stream to a server for publication in the live video feed such that the live video feed transitions from the first video stream to the second video stream.

4. A computing device for live video editing comprising:
a communication interface to enable one or more network connections, such that the computing device is capable of receiving a plurality of video streams and of transmitting a live video feed;
a visual output; and
a video editing software module, wherein the video editing software is capable of
transmitting the plurality of video streams to the visual output for display;
accepting a user selection of a first video stream from the plurality of video streams to be published in a live video feed;
transmitting the first video stream to a server for publication in the live video feed;
accepting a user selection of a second video stream from the plurality of video streams to be published in a live video feed; and
transmitting the second video stream to a server for publication in the live video feed such that the live video feed transitions from the first video stream to the second video stream.

5. A video encoding device comprising:
a video encoder;
one or more video input interfaces capable of connecting to a camera;
a visual display and input device; and
one or more transmission output interfaces,
wherein the video encoder is capable of
receiving a video stream from the camera via the one or more video input interfaces, encoding the video stream into a codec, and
outputting the encoded video stream to the one or more transmission outputs.

6. A method for sending a multi-threaded video transmission comprising the steps of:
a. dividing a video stream into packets, wherein each packet contains information regarding the packet's order in the video stream;
b. assigning each packet to one of a plurality of threads for transmission to a destination; and
c. transmitting the video stream to the destination by having each of the plurality of threads open a connection to a destination and send the packets that are assigned to it to the destination.

7. A method for receiving a multi-threaded video transmission comprising the steps of:
a. receiving a plurality of separate transmissions containing packets related to a video stream, wherein each packet contains information regarding the packet's order in the video stream;
b. assembling the video stream by combining the packets from the separate transmissions in the order it belongs in the video stream.

8. A method for electronic publication of information comprising the steps of:
a. incentivizing users having a web page on a social media site to install a promotional app;
b. allowing the users to select a set of content they wish to promote; and
c. having the user promote the set of content selected by the user by publishing links and/or other promotional material for live stream events related to the set of content selected by the user on the web page of the user.

9. The system of claim 1 wherein the video encoding devices in each of the plurality of video capture devices encode the plurality of video streams by compressing the raw video data from the camera into a video codec or video format.

10. The system of claim 1 wherein the video editing software is capable of encoding the first video stream and the second video stream into a video codec or video format for publication.

11. The system of claim 1 wherein the computing device further receives a master sound stream.

12. The system of claim 11 wherein the computing device is further capable of allowing the user to control video delay and/or sound delay such that the first video stream can be synchronized to the master sound stream.

13. The system of claim 1 wherein the computing device is further capable of allowing the user to mix in pre-recorded sounds such that the user can add the pre-recorded sounds to the first video stream and the second video stream.

14. The system of claim 11 wherein the computing device is further capable of allowing the user the to replace a sound component of the first video steam or the second video stream with the master sound stream, and when the user so chooses, the computing device is further capable of separating a sound component and a video component of the first video steam or the second video stream and combining the master sound stream with the video component of the first video stream or the second video stream.

15. The system of claim 11 wherein the computing device is further capable separating out a plurality of sound streams from the plurality of video streams, allowing the user to select whether a video component of the first video stream or second video stream is to be combined with one or more of the master sound stream, one or more of the plurality of sound streams, and pre-recorded sounds, and combining the one or more of the master sound, one or more of the plurality of sound streams or pre-recorded sounds with the video component of the first video stream and second video stream in accordance with the user's selections.

16. The system of claim 15 wherein the computing device is further capable of allowing the user to separately adjust the sound volume of one or more of the master sound, one or more of the plurality of sound streams or pre-recorded sounds selected to be combined with the first video stream and second video stream, and modulating the one or more of the master sound, one or more of the plurality of sound streams or pre-recorded sounds in accordance with the user's adjustments prior to, or as, they are combined with the first video stream and second video stream.

17. The system of claim 1 wherein the computing device is further capable of separating out a plurality of sound streams from the plurality of video streams, allowing the user to select a first sound stream and a second sound stream from the plurality of sound streams, and combining the first sound stream with the first video stream and the second sound stream with the second video stream.

18. The system of claim 1 wherein a first video capture device of the plurality of video capture devices further transmits status information to the computing device and the computing device is further capable of displaying the status information to the user.

19. The system of claim 18 wherein the status information includes signal strength of the video capture device to a router of the one or more routers through which the first video capture device is connects to the network.

20. The system of claim 18 wherein the status information includes the battery life of one or more of the camera or video encoding device of the first video capture device.

21. The system of claim 18 wherein the status information includes the identity of a router of the one or more routers with which the video capture device is associated.

22. The system of claim 1 wherein the server to which the computing device is capable of transmitting the live video feed resides on the computing device.

23. The system of claim 1 wherein the server to which the computing device is capable of transmitting the live video feed is remotely located.

24. The system of claim 1 wherein the computing device is further capable of allowing the user to select the first video stream and the second video stream by clicking on one of the displayed plurality of video streams.

25. The system of claim 1 wherein the computing device is further capable of displaying a control panel.

26. The system of claim 25 wherein a sound stream for the live feed can be adjusted using controls in the control panel.

27. The system of claim 18 wherein the status information of the first video capture device is displayed in the same area where a related video stream of the plurality of video streams is displayed, wherein the related video stream is the one that is provided to the computing device from the first video capture device.

28. The video encoding device of claim 5 further comprising a battery bank.

29. The video encoding device of claim 28 wherein the battery bank comprises a plurality of batteries and the video encoding device further comprises a battery selector.

30. The video encoding device of claim 29 further comprising a micro controller capable of periodically assessing the relative strength of the plurality of batteries in the battery bank and selecting a battery from the battery bank to power the video encoding device.

31. The video encoding device of claim 28 wherein the video encoding device further comprises a battery charger.
